(19) United States
(12) Patent Application Publication
(10) Pub. No.: US 2012/0046379 A1
(43) Pub. Date: Feb. 23, 2012

(54) METHOD OF MAKING A HARD LATEX AND A HARD LATEX

(75) Inventors: Joseph Keddie, London (GB); Argyrios Georgiadis, Guildford (GB)

(73) Assignee: THE UNIVERSITY OF SURREY, Guildford, Surrey (GB)

(21) Appl. No.: 13/203,342

(22) PCT Filed: Feb. 26, 2010
(86) PCT No.: PCT/GB2010/000343

§ 371 Date: Nov. 7, 2011

(30) Foreign Application Priority Data
Feb. 26, 2009 (GB) 0903297.0

(51) Int. Cl. C08J 3/28; C08K 5/3467; C08K 5/08; C08K 3/22; C08L 81/02; C08L 21/02; C08K 5/3415; C08K 5/3417; C08L 79/04; C08L 33/12; C08L 25/14; C08L 31/04; C08K 3/36; C08K 3/04; B82B 3/00; B82Y 30/00

(52) U.S. Cl. 522/75; 522/86; 522/79; 522/81; 524/543; 977/842; 977/742

(57) ABSTRACT

A method of making a hard latex from a latex comprising an aqueous dispersion of a polymer, the method comprising the step of exposing the latex to infrared radiation.

The invention relates to a method of making a hard latex and to a hard latex made by that method. The invention is particularly useful for making hard latex coatings, and may also be used for making hard latex sheets.

Polymer coatings are used widely in many industries, including the automotive, aerospace, shipping, home appliance, and furniture industries. Many applications require hard, scratch-resistant coatings. It is often preferable that coatings are transparent.

In the past, hard coatings were deposited by dissolving polymers in organic solvents. However, environmental and health legislation now requires industries to deposit coatings without the emission of volatile organic compounds (VOCs), such as organic solvents.

One alternative is to create a waterborne coating in which colloidal polymer particles, typically about 100 to 400 nm in diameter, are dispersed in water. This colloidal dispersion, referred to hereinafter as “a latex” is spread on a surface, and the water is allowed to evaporate. If the polymer particles are at a temperature above their glass transition temperature, then they are “soft” enough to fuse together to create a continuous coating. The resulting film will be soft, and it will be easy to scratch, abrade or destroy.

To make a hard polymer coating from a latex process, a polymer with a glass transition temperature (T_{g}) that is much higher than the application temperature can be used. To enable the latex film formation, small molecules (called plasticisers) are typically added to the latex to reduce the T_{g} of the latex. However, plasticisers are not favourable because they release VOCs into the atmosphere during the film formation process.

Alternatively, to avoid the use of plasticisers, a hard coating can be made by heating the latex to a temperature well above the T_{g} of the polymer. For instance, polystyrene and poly(methyl methacrylate) polymers have a T_{g} of about 100° C. and 110° C., respectively. Accordingly, polystyrene and poly(methyl methacrylate) latex without added plasticisers must be heated to temperatures significantly above 100° C. and 110° C., respectively.

In the past, the heating of latex films has been done using conventional convection ovens. However this has the following disadvantages: (1) the high energy use of the ovens, (2) the length of the process unless very high temperatures are used, and (3) the tendency for the films to crack during drying.

It is an object of the invention to seek to mitigate these disadvantages.

Accordingly, the invention provides a method of making a hard latex from a latex comprising an aqueous dispersion of a polymer, the method comprising the step of exposing the latex to infrared radiation.

The term “infrared radiation” as used herein means radiation of wavelength in the range between 0.7 μm and 30 μm.

The present invention utilises the fact that polymers and water absorb infrared radiation strongly at certain characteristic wavelengths. This means that, if a latex is exposed to infrared radiation, the polymer particles will absorb the radiation and increase in temperature. The water will also absorb the radiation and increase in temperature. The polymer particles will then soften and be able to coalesce to create a film.

An infrared lamp typically uses less energy than a convection oven, and so the process of the present invention is more energy efficient than the known process of using convection ovens to create a hard latex. Moreover, as the process takes place at a temperature above the polymer T_{g}, it is not necessary to use any plasticisers and so no VOCs are emitted. In addition, the process is readily adapted to an industrial scale. Finally, because heat is generated within the latex rather than being transferred into the centre of the latex by convection, the process of the present invention is able to be applied to make a hard latex coating on a surface that is sensitive to high temperatures.

Latex film formation consists of several stages: (1) evaporation of water and particle packing; (2) particle deformation to close the voids between the particles; and (3) diffusion of molecules across the particle boundaries to erase the interfaces. Together stages (2) and (3) can be referred to as “sintering”. Latex films are cloudy when the particles have not sintered (because of light scattering), but they become clear after sintering.

Particles will not be deformed and molecules will not diffuse at temperatures below the polymer glass transition temperature (T_{g}). As temperature increases above T_{g}, the polymer viscosity decreases, and the deformation and diffusion stages are faster. As temperature increases, water evaporates faster. The applicant has found that if water evaporates at a temperature less than T_{g}, film cracking is likely to result, but at temperatures above T_{g}, films are less subject to cracking. The applicant believes that this is because of stress created by capillary forces when hard particles do not deform from their spherical shape.

Accordingly, the exposure conditions are preferably such that the temperature of the polymer is raised above its glass transition temperature, more preferably at least 15° C. above its glass transition temperature.

The temperature of the polymer will be affected by the conditions under which the latex is exposed to the infrared such as the wavelength of the infrared radiation, the intensity of the infrared radiation, the length of exposure to the infrared radiation and the distance between the infrared source and the latex coating. Accordingly, these parameters may be adjusted as required in order to obtain the desired results.

The wavelength should preferably be at the wavelength at which the polymer has the greatest absorption coefficient. Alternatively, the wavelength of the infrared radiation should preferably be in the range from 0.7 μm to 30 μm, more preferably in the range from 0.7 μm to 1.8 μm.

The exposure time should be adjusted to a length that is suitable for a particular latex thickness and composition. Preferably, the length of exposure to the infrared radiation is in the range between 0.1 and 60 minutes, more preferably in the range between 0.1 and 10 minutes, and most preferably in the range between one and five minutes.

The distance of the latex from the infrared source should be adjusted depending on the type of infrared lamp, and the composition of the polymer. Preferably, the distance of the latex coating from the infrared source is in the range between 1 and 100 cm, more preferably in the range between 5 and 30 cm, and most preferably 15 to 20 cm.

The applicant has found that the rise in temperature of the polymer does not only depend on the exposure conditions, it also depends on the ability of the polymer to absorb infrared radiation. The better the polymer is at absorbing infrared radiation, the greater the rise in temperature. Accordingly, the polymer is preferably selected according to its ability to absorb infrared radiation.

The present invention does not rely on a curing process in which chemical reactions cause cross-linking of polymers. Accordingly, the polymer may contain no chemical crosslinkers (i.e. reactive chemical groups). The polymer may be selected from the group consisting of acrylic, styrene and vinyl co-polymers. The polymer may also be combined with polymers or compounds that are strongly absorbing of infrared radiation (see below).

The polymer preferably has a T_{g} in the range from 15° C. to 200° C., more preferably in the range from 20° C. to 90° C., most preferably in the range from 30° C. to 60° C. Although the invention could be applied to so-called “soft latexes” (latexes which have a T_{g} below room temperature) as well as “hard latexes” (latexes which have a T_{g} above room temperature), a hard latex coating will not be obtained at room temperature unless the latex is a hard latex. Accordingly, the latex is preferably a hard latex having a T_{g} above room temperature.

The applicant has found that, where the latex is in the form of a coating, increasing the thickness of the latex coating decreases the sintering time. Preferably, the thickness of the latex coating is in the range between 0.5 μm and 1 cm thick, more preferably between 2 μm and 1 mm thick, and most preferably between 10 μm and 100 μm thick.

In order to form a latex coating, the wet latex should be cast onto a substrate. Any suitable substrate may be used, for example, glass, steel, aluminium, or wood. Preferably, the substrate should be smooth.

The latex may be dried before being exposed to infrared radiation. This may be done by allowing the free evaporation of water or by speeding the evaporation of water with flowing air or by heating to temperatures less than 100° C. but greater than room temperature.

Alternatively, the latex may not be dried before being exposed to infrared radiation.

The applicant has found that, where the latex is not dried before being exposed to the infrared radiation, then exposure to the radiation can cause the water in the latex to overheat and boil, resulting in bubbles being created in the hard latex. Accordingly, the latex is preferably intermittently exposed to infrared radiation, the latex being allowed to cool in between exposures. In between each exposure, the latex is preferably allowed to cool so as to prevent the water from reaching its boiling point. The length of the cooling period is preferably in the range between 10 seconds and 10 minutes, more preferably in the range between 30 seconds and 5 minutes, and most preferably about 1 minute.

As discussed above, the present invention utilises the fact that polymers absorb infrared radiation. The applicant has found that the sintering time is reduced if the latex comprises an additional infrared absorber. The applicant believes that this is because the additional infrared absorber will increase the amount of heat that is absorbed by the latex causing a faster evaporation rate of the water and also transferring heat to the polymer.

The additional infrared absorber may be dispersed in the aqueous phase using appropriate dispersants, emulsifiers or encapsulations. Alternatively, the additional infrared absorber may be incorporated into the polymer particles via techniques of emulsion polymerisation, such as miniemulsion polymerisation.

The additional infrared absorber preferably comprises carbon nanotubes. Carbon nanotubes are strongly absorbing in the near IR range around 800 nm. The carbon nanotubes can be made by any number of methods such as chemical vapour deposition or laser ablation. The carbon nanotubes may be single-walled, double-walled or multi-walled.

Including carbon nanotubes greatly reduces the sintering time, offering further energy and efficiency savings on an industrial production scale. Carbon nanotubes also reduce the amount of film cracking during the drying of latex. Moreover, carbon nanotubes can potentially increase the scratch and mar-resistance of the hard latex and can potentially increase the elastic modulus of the hard latex. Carbon nanotubes offer particular advantages for (1) polymers that do not absorb strongly in the infrared range (and hence would not be heated by infrared radiation) and for (2) polymers that have a high glass transition temperature (and hence would not melt under infrared radiation).

The amount of carbon nanotubes in the latex is preferably in the range between 0.0001 wt. % and 10 wt. % on the polymer weight, more preferably in the range between 0.001 wt. % and 1 wt. % on the polymer weight, and most preferably in the range between 0.01 wt. % and 0.1 wt. % on the polymer weight.

Although the additional infrared absorber preferably comprises carbon nanotubes, another infrared absorber may be used. Thus, the additional infrared absorber may be selected from the group consisting of stacked naphthalimide anion radicals, fused porphyrin arrays, sandwich-type lanthanide bis-phthalocyanines, radical anions of conjugated diquinones (also called semiquinones), mixed-valence dinuclear metal complexes, tungsten oxide, vanadium dioxide, carbon black, a colloidal dispersion of ceramic nanoparticles, such as NIR-A1 (manufactured by Ciba Corporation), poly(3,4-ethylenedioxythiophene) and poly(pyrrole). Poly(3,4-ethylenedioxythiophene) or any other polythiophene, and poly(pyrrole) are infrared absorbing polymers and could be incorporated into the latex polymer by techniques of emulsion polymerisation.

If an additional infrared absorber is present, then the wavelength of the infrared radiation may be adjusted accordingly. Thus, it may be adjusted so that it is substantially the same as the wavelength at which the additional infrared absorber(s) have the greatest absorption coefficient.

Hard particles, such as particles made of silicon dioxide or a nanocomposite of silicon dioxide, may be added to a latex, so as to increase the hardness of the coating.

The invention will now be illustrated, by way of example only, with reference to the following figures:

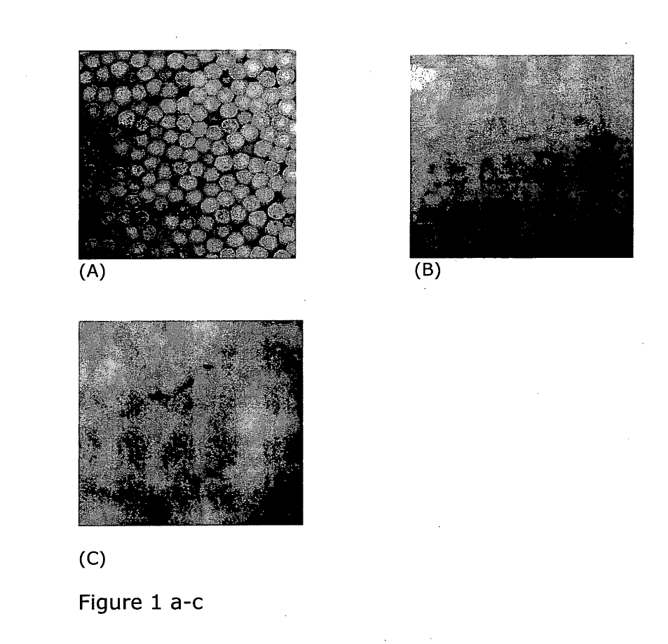

FIGS. 1a to 1c show atomic force microscopy images of three of the films made in Example 1;

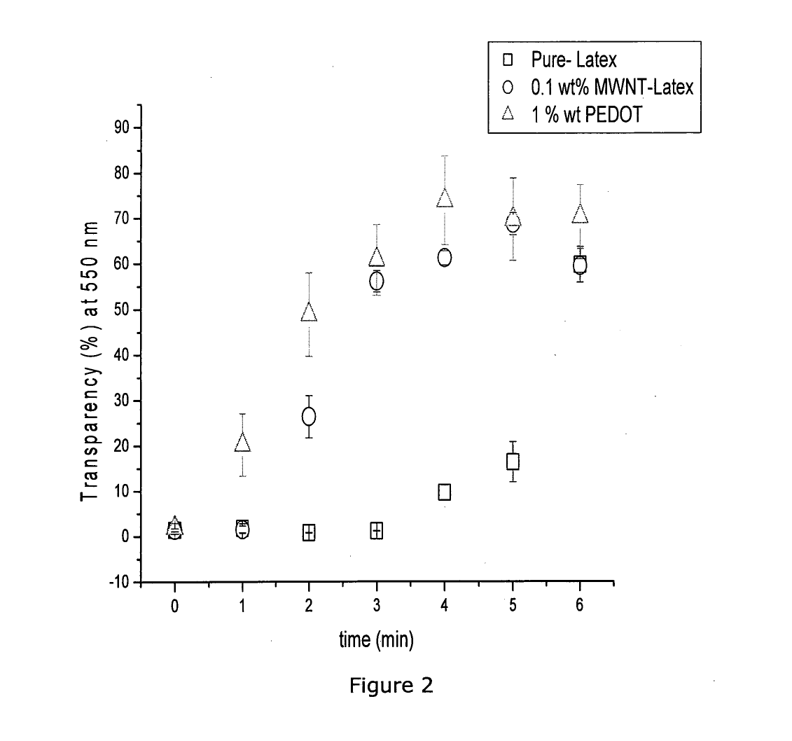

FIG. 2 shows the time dependence of optical transparency during the exposure of latex films to IR radiation;

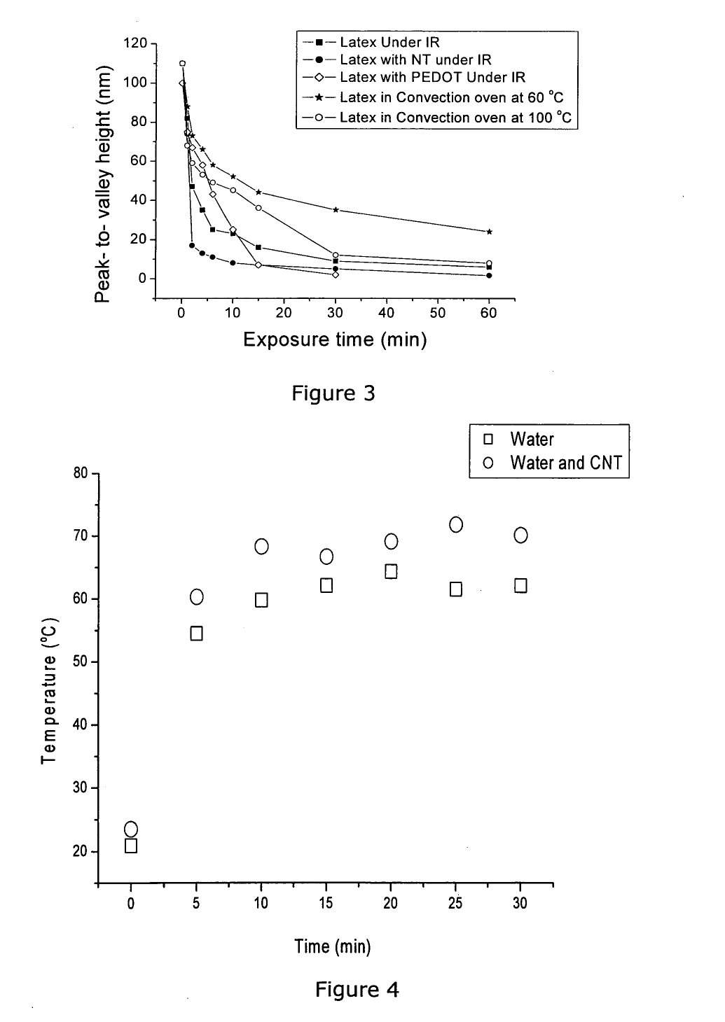

FIG. 3 shows the peak-to-valley height of the films of Example 2 as a function of the time of exposure to IR radiation or a convection oven;

FIG. 4 shows the temperature of pure water and a 0.013 wt % solution of multiwalled carbon nanotubes in pure water as a function of the length of IR exposure time;

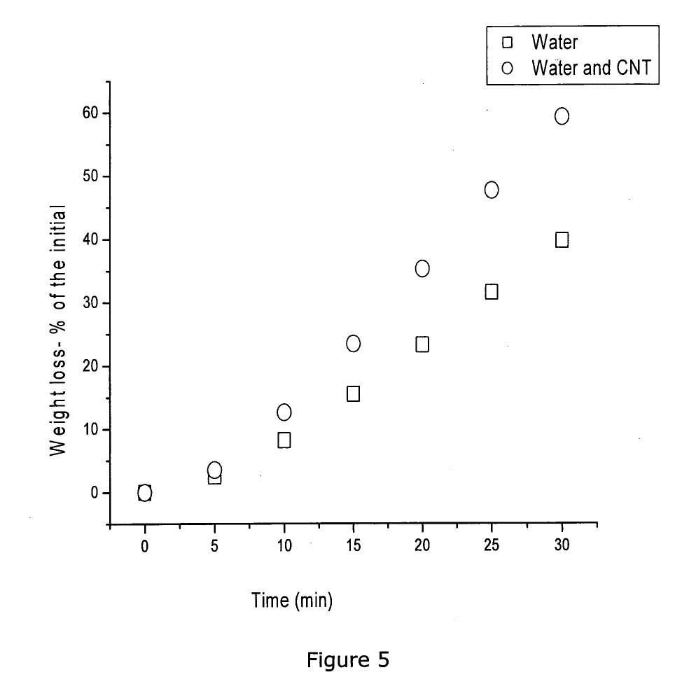

FIG. 5 shows water loss as a function of IR irradiation time for pure water and a 0.013 wt % solution of multiwalled carbon nanotubes;

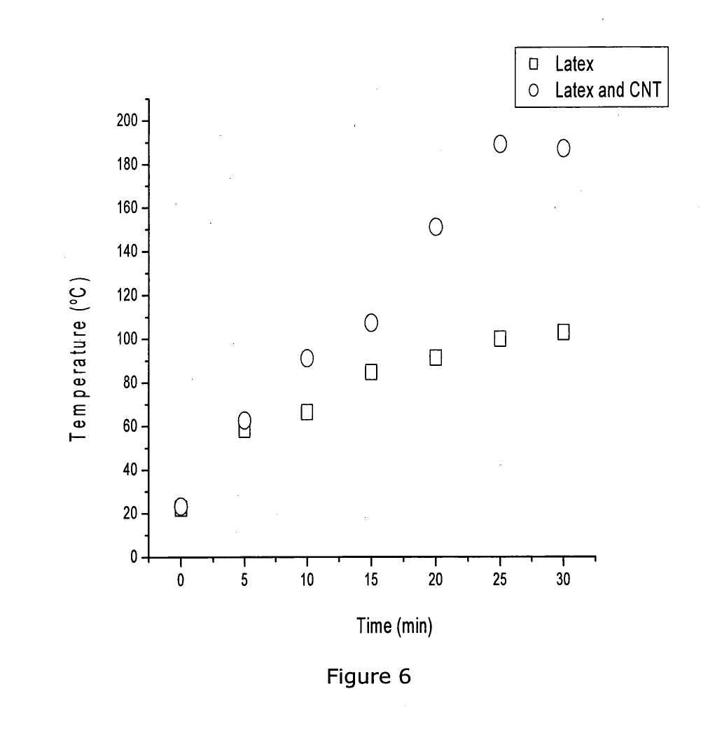

FIG. 6 shows the temperature of wet latex and a 0.021 wt % solution of multiwalled carbon nanotubes in latex as a function of the length of IR exposure time;

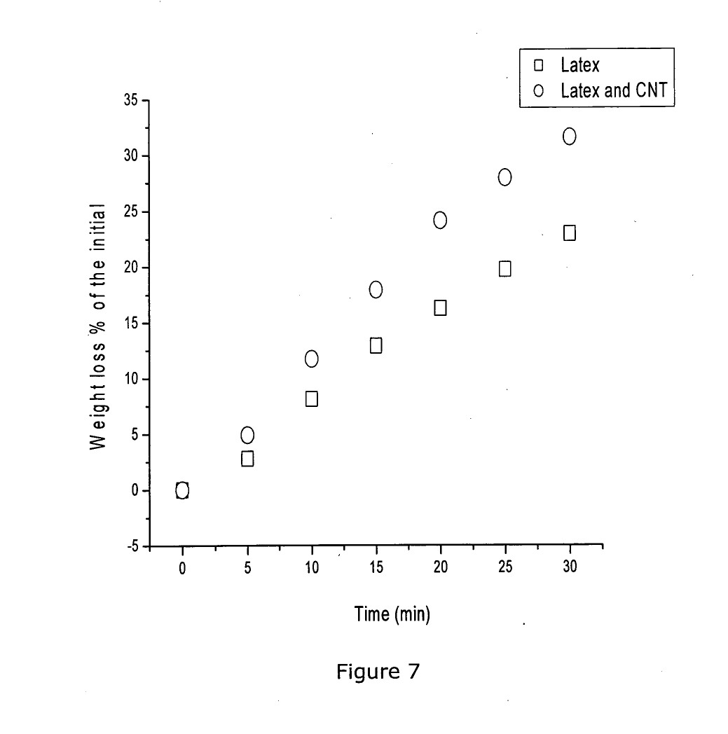

FIG. 7 shows water loss as a function of IR irradiation time for wet latex and a 0.021 wt % solution of multiwalled carbon nanotubes in latex;

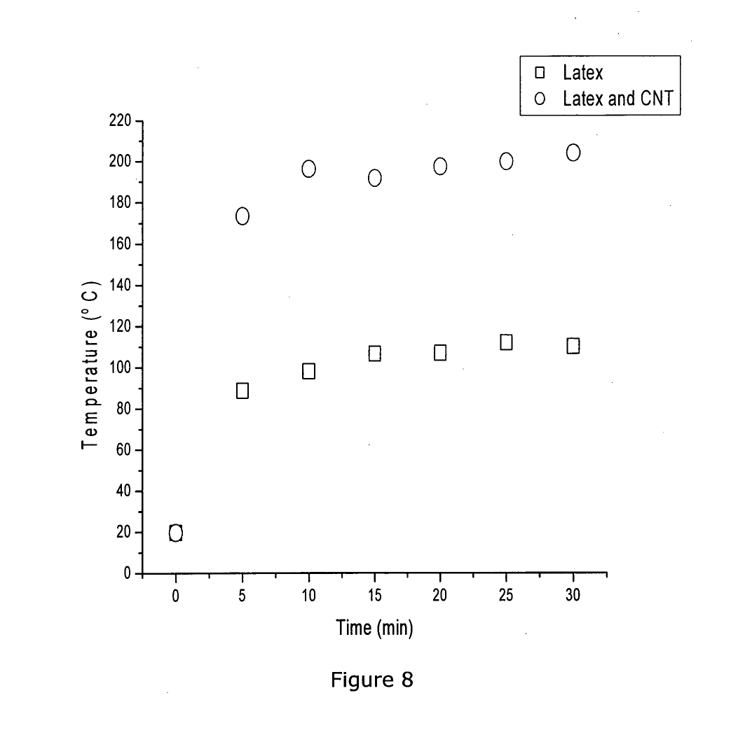

FIG. 8 shows the temperature dependence of latex skin layers on the time of IR irradiation for a latex surface and a 0.021 wt % solution of multiwalled carbon nanotubes in latex;

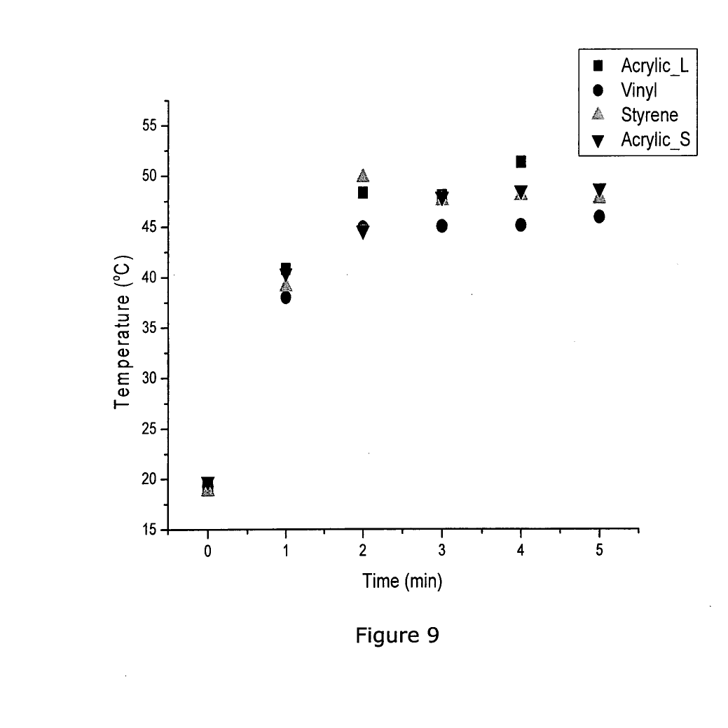

FIG. 9 shows the temperature dependence of various wet latex films on the time of IR irradiation; and

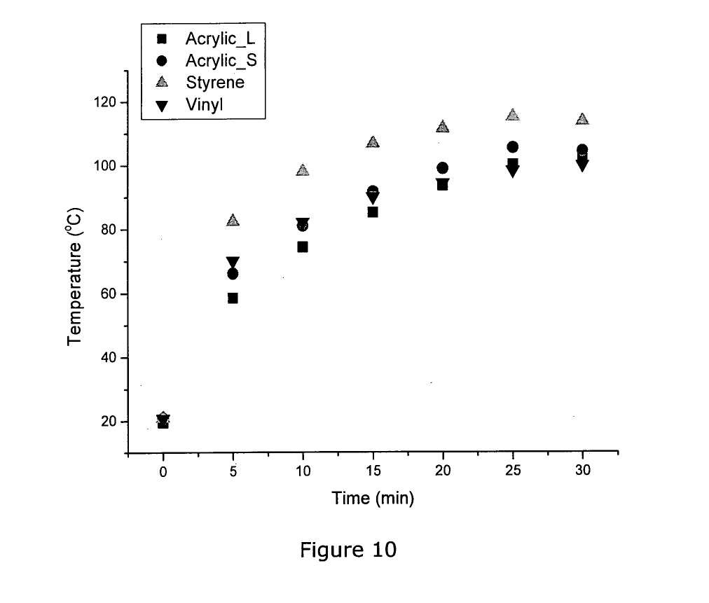

FIG. 10 shows the temperature dependence of various dry latex films on the time of IR irradiation.

### EXAMPLE 1

### IR Heating of Dried Latex Films

An acrylic latex was made from 10 g of a copolymer of butyl acrylate, methyl methacrylate and methacrylic acid and 90 g of water. The resulting latex had an average particle size of 420 nm and a T_{g} of 38° C.

A latex film was formed by casting the latex onto a substrate at room temperature. The latex film was then allowed to dry naturally in still air at room temperature. The resulting dry latex film was brittle and powdery, because the particles have not been melted, and so have not coalesced or fused together (i.e. sintered). FIG. 1a shows the surface of this film.

The dry latex film was exposed to IR radiation of wavelengths ranging between 700 nm and 1.8 μm from a 250 W lamp at a distance of 17 cm. Within six minutes, the film became optically transparent (about 50% transmission at a wavelength of 550 nm) (see FIG. 2—squares). Optical transparency is an indicator that the air voids and spaces between the latex particles have disappeared, and so the particles have coalesced together (i.e. sintered) to make a continuous film. The films are hard, glossy and crack-free, making them suitable for a protective coating. FIG. 1b shows the surface of this film. It can be seen that the film is smoother at the nano-scale, and the particles have deformed from their initial spherical shape. The particles have started to sinter.

The example was then repeated, but this time multi-walled carbon nanotubes (0.1 wt. % calculated on the weight of the polymer) were added to the wet latex. The nanotubes were obtained from the Aldrich Chemical Company. They have an average length of 0.7 μm and an aspect ratio of 3.4. After three minutes of IR irradiation, the film had become optically transparent (see FIG. 2—circles). After three minutes of IR radiation there were clear visual differences between films with and without carbon nanotubes. The pure latex film was white and opaque, but the film containing multi-walled carbon nanotubes had gained transparency.

The example was then repeated again, but this time poly(3,4-ethlendioxythiophene) (1 wt. % calculated on the weight of the polymer) was added to the wet latex. The poly(3,4-ethylenedioxythiophene) (called PEDOT) was obtained as a solution in water from the Aldrich Chemical Company. After approximately two minutes of IR irradiation, the film had become optically transparent (see FIG. 2—triangles). After two minutes of IR radiation there were clear visual differences between films with and without poly(3,4-ethylenedioxythiophene). The pure latex film was white and opaque, but the film containing poly(3,4-ethylenedioxythiophene) had gained transparency. FIG. 1c shows the surface of the PEDOT-containing film. It can be seen that the film is very smooth at the nano-scale. The boundaries between the particles are nearly dissolved and have almost completely sintered.

The applicant believes that these results are explained by particle coalescence and sintering when the polymer particles are heated above their glass transition temperature. As temperature increases, the viscosity decreases, so that coalescence and sintering is faster.

In the above examples, the thickness of the film was between 10 and 12 μm. The examples were repeated with a film of thickness of 100 μm. For the thicker film containing carbon nanotubes, it was found that optical transparency developed in less than one minute. The applicant believes that this is because more infrared radiation is absorbed in a thicker film.

For the purposes of comparison, 12 μm-thick dry latex films were placed in a convection oven at a temperature of 60° C. The films required five to six minutes to become optically transparent. Films of the same thickness that contain carbon nanotubes became transparent within approximately three minutes. Films of the same thickness that contain poly(3,4-ethylenedioxythiophene) became transparent within approximately two minutes. The energy used by the IR lamp in two or three minutes, is believed to be less than that used in a convection oven at 60° C. in five minutes, especially when considering the energy required to heat the oven to 60° C. from room temperature.

### EXAMPLE 2

### Effect of IR on Peak-to-Valley Distance

The sintering of the particles at a coating surface can be followed over time by measuring the vertical distance between the top of a particle and the point of contact with neighbouring particles. This distance is called the peak-to-valley distance. A non-sintered film will have a peak-to-valley distance that is similar to the particle radius. A fully sintered film will have a peak-to-valley distance that is zero.

Coatings made from pure latex, latex with 0.1 wt % carbon nanotubes, and latex with 1 wt % PEDOT were made as set out in Example 1. The peak-to-valley distance was measured using atomic force microscopy. Measurements were made after the film had been exposed to IR radiation for fixed lengths of time. For comparison, coatings were placed in a convection oven at temperatures of 60° C. or 100° C. for various fixed lengths of time. FIG. 3 shows a plot of the peak-to-valley distance for the pure latex, the latex with 1 wt. % PEDOT and latex with 0.1 wt % carbon nanotubes as a function of time under IR radiation. FIG. 3 also shows the peak-to-valley distance for a latex in a convection oven at 60° C. and 100° C. for comparison. The peak-to-valley height decreases fastest for the latex with 0.1 wt % carbon nanotubes that was exposed to IR radiation. The peak-to-valley distance of the latex in the convection oven at 60° C. decreases the most slowly. After 60 minutes of heating, the surface is still not flat. This example shows that sintering is fastest under IR radiation when the latex contains carbon nanotubes. The example also shows that the addition of 1 wt % PEDOT increases the rate of sintering when a latex is exposed to IR radiation. The example also shows that the sintering of the hard latex is faster under IR radiation than when in a convection oven at 60° C. or at 100° C.

### EXAMPLE 3

### Hardness of IR Sintered Films

The hardness of films made by the process of IR sintering was measured by micro-indentation. Pure latex and latex with 1 wt % PEDOT coatings were made as set out in Example 1 but using a polymer solids content of 50 wt. %. To deposit a wet coating, 1 g of wet latex was applied to an area of 5.5 cm by 2.5 cm. The wet coatings were heated under IR radiation for times between 10 minutes and 80 minutes.

The average hardness of the pure latex coating was 418.8 MPa, and the average hardness of the latex polymer with 1 wt. % PEDOT was 472.3 MPa, which is similar to the hardness of the pure latex.

For comparison, a latex coating was made by heating in a convection oven at 100° C. for times between 10 minutes and 80 minutes. The average hardness was measured to be 465.9 MPa. Thus, the hardness of the IR sintered films were approximately the same as that of the film heated in a convection oven.

For comparison, a coating was cast from a soft latex. The latex has T_{g} of 0° C. and a particle size of 420 nm. The latex was prepared by the emulsion polymerisation of monomers of butyl acrylate, methyl methacrylate and methacrylic acid. The hardness of the film was measured to be 44 MPa, which means that it is softer than the latex of Example 1 which has a T_{g} of 38° C. This example shows that a hard latex coating is not obtained unless a higher T_{g} is used.

### EXAMPLE 4

### Steel Substrates

Films can be deposited on nearly any substrate, such as sheets of steel or sheets of aluminium. One gram of the pure latex used in Example 1 was cast on a steel sheet (5.5 cm×2.5 cm×0.75 mm) substrate and exposed to IR radiation with wavelengths ranging between 700 nm and 1.8 μm from a 250 W lamp at a distance of 17 cm for 10 min. The thickness of the film was about 100 μm. A hard, crack-free coating was formed.

### EXAMPLE 5

### Carbon Black as an IR absorber

Carbon black particles can be added to the latex to absorb IR radiation so as to increase the temperature of the latex, so as to dry the latex, and so as to cause sintering of the particles.

Conductive-grade carbon black particles were dispersed in water at a concentration of 5 wt. %. The carbon black was obtained from Cabot under the product name of Vulcan XC72. The colloidal dispersion of carbon black was then blended with the latex of Example 1.

One gram of the latex containing 0.01 wt % carbon black was cast on a glass substrate (5.5 cm×2.5 cm) and exposed to IR radiation with wavelengths ranging between 700 nm and 1.8 μm from a 250 W lamp at a distance of 17 cm for 5 min. The thickness of the film was about 100 μm. The film was hard and crack-free.

One gram of latex with 0.01 wt % carbon black was cast on a steel sheet (5.5 cm×2.5 cm×0.75 mm) and exposed to IR radiation with wavelengths ranging between 700 nm and 1.8 μm from a 250 W lamp at a distance of 17 cm for 5 min. The thickness of the film was about 100 μm. The film was hard and crack-free.

### EXAMPLE 6

### IR Heating of Wet Latex Films

One gram of the latex of Example 1 was cast onto a glass slide and exposed to IR radiation with wavelengths ranging between 700 nm and 1.8 μm from a 250 W lamp at a distance of 17 cm for seven minutes. A hard, scratch-resistant, transparent and glossy coating about 130 μm thick resulted.

The example was then repeated but this time 0.05 wt. % multi-walled carbon nanotubes (measured on the weight of the polymer) was added to the wet latex. 1.19 g of the resulting latex was cast onto a glass slide. Constant exposure of the wet film to IR radiation caused an overheating of the water and boiling, which resulted in bubbles being created in the latex film.

The example was therefore repeated with the IR radiation being applied intermittently, as follows:

2 min. IR exposure; 1 min. cool down; 1 min. IR exposure; 1 min. cool down; 1 min. IR exposure; 1½ min. cool down; 1 min. IR exposure. The resulting crack-free, hard coating was about 130 μm thick. No bubbles were formed in the latex film. The film was hard, glossy and crack-free, which makes it suitable as a protective coating.

### EXAMPLE 7

### Effect of IR on Water Evaporation Rate

Approximately 10 g of water was placed in a glass beaker and exposed to IR radiation wavelengths ranging between 700 nm and 1.8 μm from a lamp with a 250 W bulb at a distance of 17 cm. The temperature and mass were recorded at intervals of five minutes, during which time the water was not being radiated.

For comparison, a 0.013 wt. % solution of multi-walled carbon nanotubes in water was irradiated under identical conditions. The temperature and mass of the solution were recorded at five minute intervals.

The temperature as a function of IR exposure time is shown in FIG. 4 for pure water (squares) and for nanotube solutions (circles). Within five minutes of the IR exposure, the temperature in both systems rose above 50° C. The temperature of the nanotube solution was consistently higher in temperature. The temperature did not continue rising over time but approached an equilibrium value of approximately 70° C. for nanotube solutions and 60° C. for water. This demonstrates that the temperature of water increases significantly when exposed to IR radiation. Carbon nanotubes act as an IR absorber to raise the temperature further.

The effect of the elevated temperature of water on the evaporation rate is illustrated in FIG. 5 for pure water (squares) and for nanotube solutions (circles). Weight loss increases steadily when water and carbon nanotube solutions are exposed to IR radiation. The applicant believes that the rate of water loss is greater for the nanotube solutions, because of the higher temperatures achieved with the IR radiation.

For further comparison, a 0.13 wt % solution of PEDOT in water and 0.05 wt % dispersion of carbon black in water were irradiated under identical conditions. The temperature and mass were recorded at five-minute intervals.

The evaporation rates were calculated under various conditions. In addition, for comparison, the evaporation rate of pure water at room temperature was calculated. These calculations are presented in Table 1.

| | | Evaporation Rate |
|---|---|---|
| Sample | Conditions | 10⁻⁶ g/(cm² · sec) |
| Pure water | Room Temperature | 1.9 ± 0.1 |
| Pure water | Under IR | 116.9 ± 7.2 |
| Water with CNT | Under IR | 183.8 ± 10.8 |
| Water with PEDOT | Under IR | 203.8 ± 14.1 |
| Water with Carbon Black | Under IR | 158.81 ± 8.96 |

The example shows that evaporation rate of water is faster when it is exposed to IR radiation. The addition of carbon nanotubes (CNT), PEDOT or carbon black increases the evaporation rate of water under exposure to IR radiation.

### EXAMPLE 8

### Temperature Increases and Water Evaporation from Wet Latex Under IR Irradiation

Approximately 10 g of the latex of Example 1 was exposed to IR radiation with wavelengths ranging between 700 nm and 1.8 μm from a 250 W lamp at a distance of 17 cm. The temperature and the water loss were recorded over time. For comparison, a latex with 0.02 wt % (measured on the total polymer weight) of multi-walled carbon nanotubes was also exposed to IR radiation. Temperature and water weight loss were determined. The temperature was measured at the top surface of the latex using a non-contact IR thermometer. FIG. 6 compares the temperature dependence for pure latex (squares) and the latex containing nanotubes (circles).

The latex heated up to about 60° C. after five minutes of IR radiation. Thereafter the temperature increased more gradually up to about 100° C. after 30 minutes. In the presence of carbon nanotubes, the temperature at the latex surface reached about 180° C. In these experiments, a solid-like layer (i.e. a “skin”) developed at the surface of the wet latex. This skin was able to heat up to temperatures beyond the boiling point of water. The experiments show that the carbon nanotubes lead to significant heating of the latex skin layer. The temperature rise is greater than found for carbon nanotube solutions in water.

The elevated temperatures found in the presence of carbon nanotubes resulted in a greater water loss rate, as shown in FIG. 7. The amount of water loss (as a percentage of the initial weight) was consistently higher in the latex containing carbon nanotubes. The presence of the skin layer depresses the water loss rate, so that it is proportionally lower than found for pure water or for nanotube solutions in water.

In a follow-on experiment, the skin layers were removed, dried and then exposed to IR radiation. The results shown in FIG. 8 for pure latex (squares) and for the latex containing nanotubes (circles) are comparable to what was presented in FIG. 6. The temperature rise is much greater in the latex film that contains carbon nanotubes.

For comparison, a latex with an additional 0.25 wt % PEDOT and a latex with an additional 0.01 wt % carbon black were also exposed to IR radiation. As with the pure latex, the temperature and weight loss were measured.

For all the latexes, the evaporation rates under IR radiation were calculated. In addition, for comparison, the evaporation rate of pure latex at room temperature was measured. The results are presented in Table 2.

| | | Water Evaporation Rate |
|---|---|---|
| Sample | Conditions | 10⁻⁶ g/(cm² · sec) |
| Pure Latex | Room Temperature | 1.3 ± 0.2 |
| Pure Latex | Under IR | 75.5 ± 3 |
| Latex with CNT | Under IR | 102.1 ± 4.6 |
| Latex with PEDOT | Under IR | 52.6 ± 4.8 |
| Latex with Carbon Black | Under IR | 94.09 ± 3.75 |

The results show that water evaporation rate is slowest in latex at room temperature. The evaporation rate is faster when the latex is exposed to IR radiation. The evaporation rate is fastest when carbon nanotubes or carbon black is added to the latex.

### EXAMPLE 9

### IR Heating of Wet Latex Films with Differing Compositions

Experiments were carried out to determine the applicability of IR heating and film formation for latex with different compositions. Latex compositions based on acrylic copolymers, styrene copolymers, and vinyl copolymers were compared.

Approximately one gram of wet latex was cast onto glass slides. The films were exposed to IR radiation for five minutes, and the temperatures were recorded at one-minute intervals. FIG. 9 compares the increases in temperatures observed for several types of latex (acrylic copolymer-L, acrylic copolymer-S, styrene copolymer, and vinyl copolymer). The acrylic copolymer was made from methyl methacrylate, butyl acrylate, and methacrylic acid. The acrylic copolymer-L has an average particle size of 420 nm (i.e. “large”). It has a T_{g} of approximately 38° C. The acrylic copolymer-S has an average particle size of 250 nm (i.e. “small”). The styrene copolymer was made from styrene, methyl methacrylate, butyl acrylate, and methacrylic acid; it has an average particle size of 250 nm. The vinyl copolymer was made from butyl acrylate, vinyl acetate, and acrylic acid; it has an average particle size of 250 nm. These latexes can be obtained from standard techniques of emulsion polymerisation. The T_{g} values for the acrylic copolymer-S, styrene copolymer, and the vinyl copolymer latexes are all approximately 30° C. IR spectroscopy shows that there are differences in the IR absorbance for these copolymers at various frequencies. The order of the strength of absorption of IR radiation depends on the wavelength of the measurement.

It can be seen from this example that IR heating is broadly applicable to a variety of latex. It can also be inferred that, the increase in the temperature depends on how strongly the polymer absorbs IR. Temperatures in the approximate range of 45 to 55° C. are achieved. For film formation, the glass transition temperature of the polymer should be lower than this temperature, as is the situation for the latex in this example.

### EXAMPLE 10

### IR Heating of Dry Latex Sheets with Differing Compositions

The latex of Example 8 were cast into moulds and exposed to IR radiation to create sheets from the different types of latex (acrylic copolymer-L, acrylic copolymer-S, styrene, copolymer, and vinyl copolymer). The resulting dry sheets were approximately 1 mm thick with a mass in the range from 0.8 to 0.9 g. This example shows that free-standing polymer sheets may be created by the IR radiation process.

The temperature rise as a function of the IR exposure time was measured for each type of latex. The results are presented in FIG. 10. It can be seen that all the different types of latex polymer increase in temperature, but there are variations in the magnitude of the increase, depending on the polymer composition. The temperature rise was greatest for the styrene copolymer. It is inferred that the styrene copolymer is most strongly absorbing in the range of the radiation emitted by the lamp.

1. A method of making a hard latex from a latex comprising an aqueous dispersion of a polymer, the method comprising the step of exposing the latex to infrared radiation.

2. A method according to claim 1, wherein the exposure conditions are such that the temperature of the polymer is raised above its glass transition temperature.

3. A method according to claim 2, wherein the exposure conditions are such that the temperature of the polymer is raised at least 15° C. above its glass transition temperature.

4. A method according to claim 1, wherein the wavelength of the infrared radiation is in the range from 0.7 μm to 30 μm, more preferably in the range from 0.7 μm to 1.8 μm.

5. A method according to claim 1, wherein the wavelength of the infrared radiation is substantially the same as the wavelength at which the polymer has the greatest absorption coefficient.

6. A method according to any claim 1, wherein the length of exposure to the infrared radiation is in the range between 0.1 and 60 minutes, more preferably in the range between 0.1 and 10 minutes, and most preferably in the range between one and five minutes.

7. A method according to claim 1, wherein the distance of the latex from the infrared source is in the range between 1 and 100 cm, more preferably in the range between 5 and 30 cm, and most preferably 15 to 20 cm.

8. A method according to claim 1, wherein the polymer is selected according to its ability to absorb infrared radiation.

9. A method according to claim 1, wherein the polymer does not contain any chemical crosslinkers.

10. A method according to claim 1, wherein the polymer is selected from the group consisting of acrylic, styrene and vinyl copolymers.

11. A method according to claim 1, wherein the polymer has a T_{g} in the range from 15° C. to 200° C., more preferably in the range from 20° C. to 90° C., most preferably in the range from 30° C. to 60° C.

12. A method according to claim 1, wherein the polymer has a T_{g} greater than 20° C., more preferably greater than 30° C.

13. A method according to claim 1, wherein the latex is in the form of a coating and the thickness of the coating is in the range between 0.5 μm and 1 cm thick, more preferably between 2 μm and 1 mm thick and most preferably in the range between 10 μm and 100 μm thick.

14. A method according to claim 1, wherein the method comprises the step of drying the latex before exposing it to infrared radiation.

15. A method according to claim 1, wherein the latex is not dried before being exposed to infrared radiation.

16. A method according to claim 15, wherein the latex is intermittently exposed to infrared radiation, the latex being allowed to cool in between exposures.

17. A method according to claim 16, wherein, in between each exposure, the latex is allowed to cool so as to ensure that the latex temperature always stays below 100° C.

18. A method according to claim 16, wherein the length of the cooling period is in the range between 10 seconds and 10 minutes, more preferably in the range between 30 seconds and 5 minutes, and most preferably about 1 minute.

19. A method according to claim 1, wherein the latex comprises an additional infrared absorber.

20. A method according to claim 19, wherein the additional infrared absorber comprises carbon nanotubes.

21. A method according to claim 20, wherein the amount of carbon nanotubes in the latex is in the range between 0.0001 wt % and 10 wt. % on the polymer weight, more preferably in the range between 0.001 wt. % and 1 wt. % on the polymer weight, and most preferably in the range between 0.01 wt % and 0.1 wt % on the polymer weight.

22. A method according to claim 19, wherein the additional infrared absorber is selected from the group consisting of stacked naphthalimide anion radicals, fused porphyrin arrays, sandwich-type lanthanide bis-phthalocyanines, radical anions of conjugated diquinones, mixed-valence dinuclear metal complexes, tungsten oxide, vanadium dioxide, carbon black, ceramic nanoparticles, poly(3,4-ethylenedioxythiophene) or any other polythiophene, and poly(pyrrole).

23. A method according to claim 19, wherein the wavelength of the infrared radiation is substantially the same as the wavelength at which the additional infrared absorber has the greatest absorption coefficient.

24. A method according to claim 1 in which hard particles, such as particles made of silicon dioxide or a nanocomposite containing silicon dioxide, are added to a latex, so as to increase the hardness of the coating.

25. (canceled)

26. A hard latex prepared by a method according to claim 1.

27. (canceled)
